(19) United States
(12) Patent Application Publication
(10) Pub. No.: US 2024/0036854 A1
(43) Pub. Date: Feb. 1, 2024

(54) METHOD AND DEVICE OF UPDATING AND TESTING MULTIPLE EMBEDDED CONTROLLERS

(71) Applicants: ELITEGROUP COMPUTER SYSTEMS CO., LTD., Taipei (TW); Golden Elite Technology (SHENZHEN) LTD., Shenzhen (CN)

(72) Inventors: MING-LUN YANG, Taipei (TW); TING-KU TUNG, Taipei (TW); YUNG-HSIEN HO, Taipei (TW)

(21) Appl. No.: 17/971,396

(22) Filed: Oct. 21, 2022

(30) Foreign Application Priority Data
Aug. 1, 2022 (TW) 111128779

(51) Int. Cl. G06F 8/65; G06F 11/36

(52) U.S. Cl. CPC G06F 8/65; G06F 11/3688

(57) ABSTRACT

A method and an electronic device of updating and testing multiple embedded controllers (ECs) are provided. First, in the electronic device, a basic input output system (BIOS) executes an updating software to read an embedded-controller read-only file (ECROF) in an external read-only memory (ROM). A first embedded controller (first EC) writes the ECROF from the external ROM into the first EC. The first EC uses the ECROF to update a first firmware of the first EC. Then, the first EC updates a second firmware of a second embedded controller (second EC) with the ECROF. Next, the first EC or another hardware device compares the first summary information stored in the first EC and the second summary information of the updated second EC. When the first summary information and the second summary information are different, the first EC or the hardware device generates a warning message.

### BACKGROUND

### 1. Field of the Invention

The present disclosure relates to a method and a device of updating and testing multiple embedded controllers, and in particularly to a method and a device of updating and testing a slave embedded controller by a master embedded controller.

### 2. Description of the Related Art

In recent years, most methods of testing the running state of an embedded controller (EC) are reading a specific register of the embedded controller through a basic input output system (BIOS) or an external hardware-checking software, such as RWEverything. Next, based on the system default value or the specifications noted in the document of the ECs, whether the firmware versions of the ECs are correct and whether the ECs normally work are checked.

However, the above checking method is not the most efficient method. If an external hardware-checking software is used to check multiple ECs of an electronic device, the external hardware-checking software only can be used to manually check the ECs one by one to see whether the ECs each running normally. This method is inefficient. Additionally, it is impossible to require an end user to execute the external software to check these ECs when turning on an electronic device, since this is an unreasonable operation.

Generally, if an electronic device has only a single EC, it is very easy to check whether the function of the single EC is normal. However, if an electronic device has multiple ECs, the functions controlled by slave ECs are mostly secondary functions (for example, LED lighting devices, connection ports, or other additional hardware on the electronic device that do not affect the boot function of the electronic device). These secondary functions do not affect the operation functions of the master EC. Therefore, if the secondary functions are not used when the electronic device is running, the slave ECs for the secondary functions won't be checked to see whether the corresponding hardware or firmware is normal. Therefore, a faster checking way is needed to ensure that the functions of all ECs are normal when these multiple ECs are verified.

### SUMMARY

According to an embodiment of the present disclosure, a method of updating and testing multiple embedded controllers (ECs) is provided. The method is used for an electronic device with multiple ECs. Through updating the firmware of the multiple ECs, the electronic device check whether the functions of the multiple ECs are normal, and the multiple ECs comprises a first embedded controllers (first EC) and a second embedded controller (second EC), and a first summary information of the second EC is stored in the first EC. The method comprises the following steps.

First, a basic input output system (BIOS) of the electronic device executes an updating software to read an embedded-controller read-only file in an external read-only memory (ROM) of the electronic device. The first EC writes the embedded-controller read-only file from the external ROM into the first EC. The first EC uses the embedded-controller read-only file to update a first firmware of the first EC. After updating the first firmware of the first EC, the first EC updates a second firmware of the second EC with the embedded-controller read-only file. After updating the second firmware of the second EC, the first EC or another hardware device compares whether the first summary information stored in the first EC is the same as the second summary information of the updated second EC. When the first summary information is not the same as the second summary information, the first EC of another hardware device generates a warning message.

According to an embodiment of the present disclosure, the BIOS writes the embedded-controller read-only file stored in an external hardware device into the external ROM of the electronic device and then transmits a success message to the first EC to make the first EC read the embedded-controller read-only file.

According to an embodiment of the present disclosure, the first summary information comprises a hash value generated by the embedded-controller read-only file through a hash function, and the second summary information comprises a second hash value generated by the second firmware of the updated second EC through the hash function.

According to an embodiment of the present disclosure, the method further comprises transmitting the warning message to the BIOS of the electronic device.

According to an embodiment of the present disclosure, the BIOS of the electronic device issues a warning when the electronic device is restarted. The methods of giving the warning comprises powering off the electronic device, not allowing turning on the electronic device, giving a beeping sound or a long and short sound by the electronic device, flashing at least a lamp of the multiple ECs, or any combination thereof.

According to an embodiment of the present disclosure, a signal connection method between the first EC and the external ROM comprises a serial peripheral interface (SPI).

According to an embodiment of the present disclosure, the second EC is in charge of a secondary function of the first EC, and the secondary function comprises an LED light function or a connection port function of the electronic device.

According to an embodiment of the present disclosure, the embedded-controller read-only file stored in the external ROM of the electronic device is a factory firmware file.

According to an embodiment of the present disclosure, the first EC writes the factory firmware file into the multiple ECs to restore firmware parameters of the multiple ECs to default values.

The embodiment of the present disclosure, an electronic device with multiple embedded controllers capable of performing the method above are provided. The multiple embedded controllers comprise a first embedded controller and a second embedded controller. The electronic device comprises multiple hardware modules for executing the above-mentioned methods of updating and testing the multiple ECs.

In light of the foregoing, compared with the prior arts for updating and testing multiple ECs of an electronic device one by one, the method for updating and testing multiple ECs provided by some embodiments of the present disclosure and the electronic device thereof can be more efficient. The embodiments of the present disclosure may more completely check whether the hardware functions of the multiple ECs are damaged or whether the firmware versions of the ECs have errors that cause the operating function of the electronic device error.

To further understand the technology, means, and effects of the present disclosure, reference may be made by the detailed description and drawings as follows. Accordingly, the purposes, features, and concepts of the present disclosure can be thoroughly and concretely understood. However, the following detailed description and drawings are only used to reference and illustrate the implementation of the present disclosure, and they are not used to limit the present disclosure.

### BRIEF DESCRIPTION OF DRAWINGS

The drawings are provided to make the persons with ordinary skills in the field of the art further understand the present disclosure and are incorporated into and constitute a part of the specification of the present disclosure. The drawings illustrate demonstrated embodiments of the present disclosure and are used to explain the principal of the present disclosure together with the description of the present disclosure.

FIG. 1 is a diagram of a system for updating and testing multiple embedded controllers according to an embodiment of the present disclosure.

FIG. 2 is a flow chart of updating and testing multiple embedded controllers according to an embodiment of the present disclosure.

### DETAILED DESCRIPTION OF EMBODIMENTS

The embodiments of the present disclosure are described in detail as reference, and the drawings of the present disclosure are illustrated. In the case of possibility, the element symbols are used in the drawings to refer to the same or similar components. In addition, the embodiment is only one approach of the implementation of the design concept of the present disclosure, and the following multiple embodiments are not intended to limit the present disclosure.

These embodiments are provided so that this disclosure will be thorough and complete, and will fully convey the concept of the invention to those skilled in the art. About the drawings, the relative proportions and proportions of elements in the drawings may be exaggerated or reduced in size for clarity and convenience. Such arbitrary ratios are illustrative only and not limiting in any way. The same reference numbers are used in the drawings and the description to refer to the same or like parts.

It will be recognized that, although the terms “first,” “second,” “third,” etc. may be used herein to describe various elements, these elements should not be limited by these terms. These terms are only used to distinguish one component from another. Thus, a first element discussed herein could be termed as a second element without altering the description of the present disclosure. As used herein, the term “or” includes any and all combinations of one or more of the associated listed items.

It will be recognized that when an element or layer is referred to as being “on,” “connected to,” or “coupled to” another element or layer, it can be directly on, connected to, or coupled to the other element or layer. Alternatively, intermediate elements or intermediate layers may be present. In contrast, when an element is referred to as being “directly on,” “directly connected to,” or “directly coupled to” another element or layer, there are no intervening elements or layers present.

In order to solve the problems of the prior art, an embodiment of the present disclosure provides a method for updating and testing multiple embedded controllers and an electronic device thereof. A user can update and test the multiple embedded controllers through the above-mentioned updating and testing method to effectively reduce the time for updating and testing the multiple embedded controllers and improving work efficiency. For example, but not limited thereto, an electronic device with multiple embedded controllers may as a smart home appliance, a game console, an automotive electronic system, or a desktop computer.

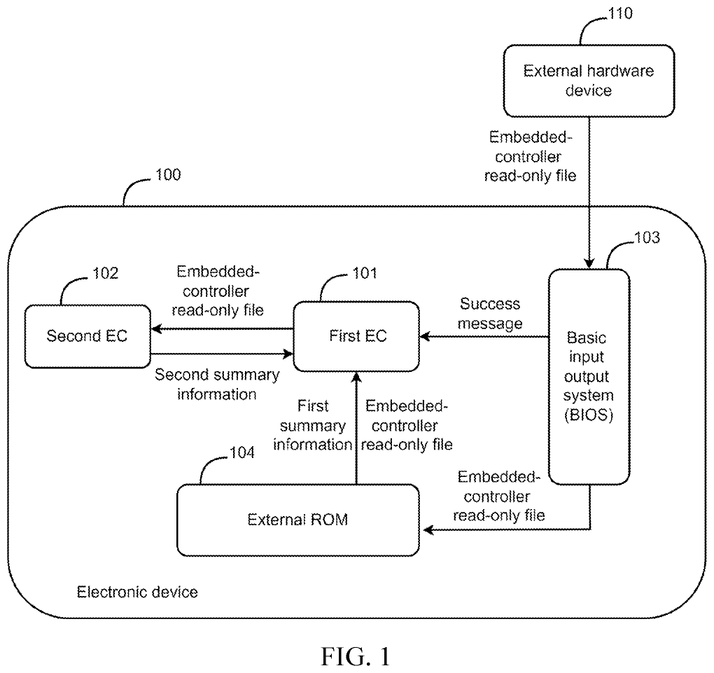

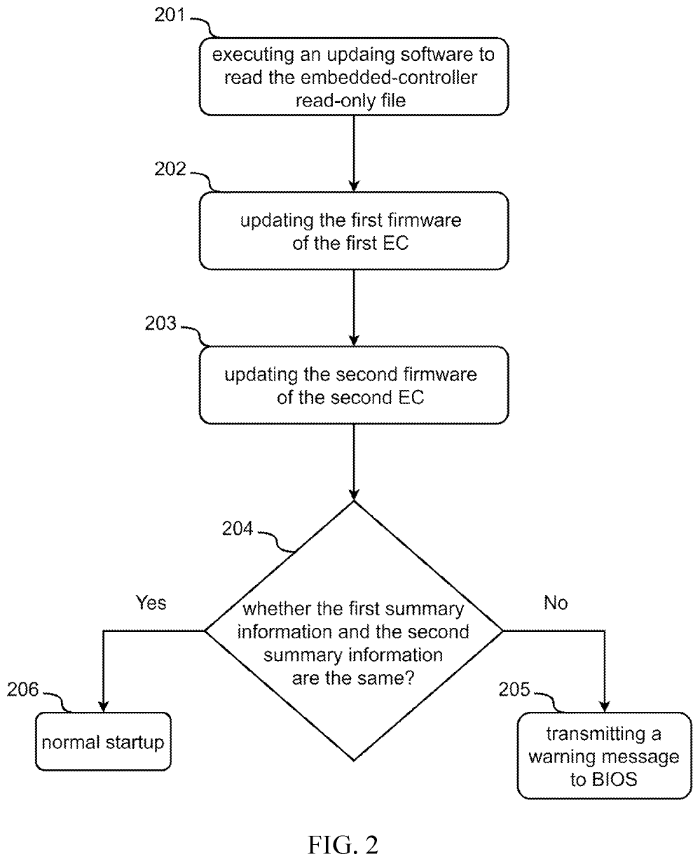

FIG. 1 is a diagram of a system for updating and testing multiple embedded controllers according to an embodiment of the present disclosure. FIG. 2 is a flow chart of updating and testing multiple embedded controllers according to an embodiment of the present disclosure. The flow chart for updating and testing multiple embedded controllers in FIG. 2 may be executed in the system for updating and testing of the multiple embedded controllers in FIG. 1.

In step 201, a basic input output system (BIOS) 103 executes an updating software to read an embedded-controller read-only file stored in an external read-only memory (ROM) 104.

For example, but not limited thereto, the above-mentioned embedded-controller read-only file stored in the external ROM 104 may be a factory firmware file of a corresponding embedded controller (EC), and the factory firmware file is usually stored in a register or a ROM of an EC. When the maintenance engineers solve hardware problems, they can use the embedded-controller read-only file to restore the parameter values of the electronic device 100 and check whether a problem occurs on the hardware or the firmware version of the EC.

Alternatively, before the BIOS 103 executes the firmware in the first embedded controllers (first EC) 101 or the second embedded controller (second EC) 102 of the electronic device 100, the BIOS 103 may read the embedded-controller read-only file stored in the external hardware device 110 (for example, a USB disk), and then write the embedded-controller read-only file into the external ROM 104 to provide the first EC 101 read the embedded-controller read-only file.

In other words, the embedded-controller read-only file transmitted to the first EC 101 and the second EC 102 may be an updated firmware file provided by the external hardware device 110 or a restoration firmware file stored in the external ROM 104 of the electronic device 100.

According to some other embodiments, the embedded-controller read-only file stored in the external ROM 104 may be one or more firmware code files with multiple versions. Therefore, a user can select a read-only file with a specific firmware version, depending on different operation modes of the electronic device 100, to be transmitted to the first EC 101, the second EC 102, or both to change the first firmware version, the second firmware version, or both to make the electronic device 100 has various operation modes.

In step 202, the first EC 101 writes the embedded-controller read-only file stored in the external ROM 104 into the first EC 101 and updates the first firmware of the first EC. For example, but not limited thereto, the first EC 101 and the external ROM 104 are signal connected according to the Serial Peripheral Interface (SPI) specification. SPI is a signal connection relationship between a master device and one or more slave devices. SPI comprises four transmission signal bus, wherein two of which are signal bus for transmitting data, one for transmitting the clock, and the other for selecting the slave device. For example, but not limited thereto, according to some embodiments of the present disclosure, the first EC 101 may be regarded as the master device of the SPI, and the external ROM 104 may be regarded as the slave device.

In step 203, after updating the first firmware of the first EC 101, the first EC 101 updates the second firmware of the second EC 102 with the embedded-controller read-only file. For example, but not limited thereto, that the first EC 101 updates the second firmware of the second EC 102 with the embedded-controller read-only file means that the code of the embedded-controller read-only file overwrites the old firmware code stored in the second EC 102.

In step 204, after updating the second firmware, whether the first summary information stored in the first EC 101 is the same as the second summary information of the updated second EC 102 are compared. Further, the step 204 of comparing the first summary information and the second summary information may be performed by the first EC 101, or by a verification hardware module circuit that is added to the electronic device 100, but not limited thereto. The comparison result of the first summary information and the second summary information is then transferred to the BIOS 103 by the first EC 101, or the verification hardware module circuit.

For example, but not limited thereto, the first summary information may be a first hash value generated by a part of the embedded-controller read-only file for updating the second EC 102 through a hash function, and the first summary information is stored in the first EC 102. The second summary information may be a second hash value generated by the updated second firmware of the second EC 102 through the same hash function. Generally, when the first hash value is the same as the second hash value, it means that the hardware of the second EC 102 is not damaged. On the contrary, when the first hash value and the second hash value are different, it means that the register of the second EC 102 or a part of its internal hardware is damaged.

In yet another embodiment, the first summary information may be a hardware capacity value of a memory module in the second controller 102 when the electronic device is shipped from the factory, and the hardware capacity value is stored in the first EC. The second summary information may be a hardware capacity value of the memory module in the updated second EC 102. Theoretically, the capacity of the memory module should be unchanged before and after the step 203 of updating the second firmware of the second EC 102. However, when the first hardware capacity value and the second hardware capacity value are different, it means that some parts of the memory module in the second EC 102 is damaged.

If the first summary information is not the same as the second summary information in step 204, then go to step 205. In step 205, a warning message is transferred to the BIOS 103. For example, but not limited thereto, when the BIOS 103 accepts the warning message, a warning is given after the electronic device 100 is restarted. Methods of giving the warning comprise powering off the electronic device 100, not allowing turning on the electronic device 100, giving a beeping sound or a long and short sound by the electronic device 100, flashing at least a lamp of the first EC 101 and the second EC 102, or any combination thereof. A user can choose one or more warning methods above to warn the user that the electronic device 100 has what kind of hardware damage or error.

If the first summary information is the same as the second summary information in step 204, then go to step 206. In step 206, the electronic device 100 is normally powered on and functioning.

To sum up, the embodiments of the present disclosure provide the method for updating and verifying multiple ECs and the electronic device thereof that can perform hardware functional check of the electronic device with multiple ECs. Compared with conventional external hardware-checking software used to check multiple ECs one by one, the method for updating and checking the ECs and the electronic device thereof, according to the embodiments of the present disclosure, can effectively reduce the needed checking time of maintenance engineers to improve their work efficiency. Therefore, according to the embodiments provided in this disclosure, the method of updating and verifying multiple ECs of an electronic device and an electronic device capable of performing the method described above has extremely high practicability and market value.

It should be understood that the examples and the embodiments described herein are for illustrative purpose only, and various modifications or changes in view of them will be suggested to those skilled in the art and will be included in the spirit and scope of the application and the scope of the appended claims.

What is claimed is:

1. A method of updating and testing a plurality of embedded controllers of an electronic device, which is used to update firmware of the plurality of the embedded controllers and check whether functions of the plurality of the embedded controllers (ECs) are normal, wherein the plurality of the ECs comprise a first embedded controllers (first EC) and a second embedded controller (second EC), and the first EC stores a first summary information of the second EC, the method comprising:
executing an updating firmware, by a basic input output system (BIOS) of the electronic device, to read an embedded-controller read-only file stored in an external read-only memory (ROM) in the electronic device;
writing the embedded-controller read-only file stored in the external ROM into the first EC by the first EC;
updating a first firmware of the first EC with the embedded-controller read-only file by the first EC;
updating a second firmware of the second EC with the embedded-controller read-only file by the first EC after updating the first firmware of the first EC;
comparing whether the first summary information stored in the first EC is the same as a second summary information of the second EC after updating the second firmware; and
generating a waring message when the first summary information and the second summary information are different.

2. The method of claim 1, further comprising writing the embedded-controller read-only file from an external hardware device into the external ROM in the electronic device by the BIOS and transmitting a write-in success message to the first EC to make the first EC read the embedded-controller read-only file.

3. The method of claim 1, wherein the first summary information comprises a first hash value generated by the embedded-controller read-only file for updating the second EC through a hash function, and the second summary information comprises a second hash value generated by the second firmware of the updated second EC through the hash function.

4. The method of claim 1, further comprising transmitting the warning message to the BIOS of the electronic device.

5. The method of claim 4, wherein the BIOS of the electronic device issues a warning when the electronic device is restarted, and a method of issuing the warning comprises powering off the electronic device, not allowing turning on the electronic device, giving a beeping sound or a long and short sound by the electronic device, flashing at least a lamp of the plurality of the ECs, or any combination thereof.

6. The method of claim 1, wherein a signal connection method between the first EC and the external ROM comprises a serial peripheral interface.

7. The method of claim 1, wherein the second EC is in charge of a secondary function of the first EC, and the secondary function comprises an LED light function or a connection port function of the electronic device.

8. The method of claim 1, wherein the embedded-controller read-only file stored in the external ROM of the electronic device is a factory firmware file.

9. The method of claim 8, wherein the first EC writes the factory firmware file into the plurality of the ECs to restore firmware parameters of the plurality of the ECs to default values.

10. An electronic device with a plurality of embedded controllers capable of preforming the method of claim 1, wherein the electronic device comprises the first EC, the second EC, the BIOS, and the external ROM.
